(19) United States
(12) Patent Application Publication
(10) Pub. No.: US 2025/0219059 A1
(43) Pub. Date: Jul. 3, 2025

(54) COMPOSITE ANODE ACTIVE MATERIAL INCLUDING A DOUBLE LAYER AND A METHOD OF MANUFACTURING SAME

(71) Applicants: HYUNDAI MOTOR COMPANY, Seoul (KR); KIA CORPORATION, Seoul (KR); PUKYONG NATIONAL UNIVERSITY INDUSTRY-UNIVERSITY COOPERATION FOUNDATION, Busan (KR)

(72) Inventors: Yoon Kwang Lee, Suwon-si (KR); Yun Sung Kim, Seoul (KR); Ga Hyeon Im, Hwaseong-si (KR); Kyu Joon Lee, Seoul (KR); Hong Seok Min, Yongin-si (KR); So Young Lee, Suwon-si (KR); Su Jong Chae, Busan (KR); Min Seong Ko, Busan (KR); Jae Won Kim, Yangsan-si (KR); Jin Su Lee, Busan (KR)

(73) Assignees: HYUNDAI MOTOR COMPANY, Seoul (KR); KIA CORPORATION, Seoul (KR); PUKYONG NATIONAL UNIVERSITY INDUSTRY-UNIVERSITY COOPERATION FOUNDATION, Busan (KR)

(21) Appl. No.: 18/824,437

(22) Filed: Sep. 4, 2024

(30) Foreign Application Priority Data
Dec. 29, 2023 (KR) 10-2023-0195923

(51) Int. Cl. H01M 4/36; H01M 4/02; H01M 4/04; H01M 4/133; H01M 4/134; H01M 4/38; H01M 4/583

(52) U.S. Cl. CPC H01M 4/366; H01M 4/0428; H01M 4/133; H01M 4/134; H01M 4/386; H01M 4/583; H01M 2004/021; H01M 2004/027

(57) ABSTRACT

A composite anode active material including a double layer and a method of manufacturing the same are disclosed. In coating the surface of carbon-based particles with a coating layer having high energy density, a buffer layer is formed between the carbon-based particles and the coating layer. Charge/discharge efficiency of an all-solid-state battery including the anode active material is thereby improved. The anode active material has a core including carbon-based particles, a buffer layer covering at least a portion of a surface of the core and including a carbide, and a coating layer covering at least a portion of a surface of the buffer layer and including a lithiophilic material.

### CROSS-REFERENCE TO RELATED APPLICATION

This application claims, under 35 U.S.C. § 119(a), the benefit of priority to Korean Patent Application No. 10-2023-0195923, filed on Dec. 29, 2023, the entire contents of which are incorporated herein by reference.

### BACKGROUND

### (a) Technical Field

The present disclosure relates to a composite anode active material including a double layer and to a method of manufacturing the same. Specifically, in coating the surface of carbon-based particles with a coating layer having high energy density, a buffer layer is formed between the carbon-based particles and the coating layer.

### (b) Background Art

A battery is configured to store power using water capable of electrochemical reaction in the cathode and anode. A representative example of such batteries is a lithium secondary battery that stores electrical energy by a difference in chemical potential when lithium ions are intercalated/deintercalated in the cathode and anode.

The lithium secondary battery is manufactured by using materials capable of reversible intercalation/deintercalation of lithium ions as cathode and anode active materials and by loading an organic electrolyte solution, a polymer electrolyte solution, or a solid electrolyte between the cathode and the anode.

Although the anode active material of most commercialized lithium secondary batteries is graphite, there are limitations in manufacturing lithium secondary batteries with high energy density due to low theoretical capacity of graphite (372 milliampere-hours per gram mass (mAh/g)). As substitutes for graphite, silicon (3,579 mAh/g) and lithium metal (3,682 mAh/g), which have high theoretical capacity, are receiving attention. However, silicon has a volume change rate of up to 300% when charging and discharging the battery, and thus use of silicon in combination with graphite rather than alone is proposed.

With regard thereto, there is a known method of manufacturing a composite anode active material by coating the surface of graphite with silicon using chemical vapor deposition (CVD), etc. In this case, however, adhesion between graphite and silicon is poor, and thus detachment may occur easily during charging and discharging. In this way, when detachment between graphite and silicon occurs, battery performance deteriorates, and initial charge/discharge efficiency decreases.

### SUMMARY

The present disclosure has been made keeping in mind the problems encountered in the related art and is intended to provide an anode active material capable of increasing initial charge/discharge efficiency of a battery.

Specifically, the present disclosure is intended to provide an anode active material capable of enhancing adhesion therebetween when coating the surface of a carbon material such as graphite with a lithiophilic material such as silicon.

In addition, the present disclosure is intended to solve the problem in which a non-uniform coating layer is formed when the surface of the carbon material is directly coated with the lithiophilic material using chemical vapor deposition.

In particular, silicon, an example of a lithiophilic material, undergoes large volume expansion when the structure thereof changes from amorphous to crystalline. Thus, the present disclosure is intended to provide an anode active material capable of suppressing crystallization of silicon during charging.

The objects of the present disclosure are not limited to the foregoing. The objects of the present disclosure should be more clearly understood through the following description and may be realized by the technical concepts described in the claims and combinations thereof.

An aspect of the present disclosure may provide an anode active material. The anode active material may have a core including carbon-based particles, a buffer layer covering at least a portion of a surface of the core and including a carbide, and a coating layer covering at least a portion of a surface of the buffer layer and including a lithiophilic material.

In one embodiment, the carbon-based particles may include at least one selected from the group comprising or consisting of natural graphite, artificial graphite, or any combination thereof.

In one embodiment, the carbide may include silicon (Si) and carbon (C) according to SiCₓ (0<x≤1). The carbide may include silicon carbide SiCₓ (0<x≤1).

In one embodiment, a thickness of the buffer layer may be 1 nanometer (nm) to 20 nm.

In one embodiment, the lithiophilic material may include a metal or metalloid capable of forming an alloy with lithium. The metal or metalloid capable of forming an alloy with lithium may include at least one selected from the group comprising or consisting of silicon (Si), gold (Au), platinum (Pt), palladium (Pd), silver (Ag), aluminum (Al), magnesium (Mg), bismuth (Bi), tin (Sn), zinc (Zn), or any combination thereof.

In one embodiment, the lithiophilic material may include amorphous silicon (Si).

In one embodiment, a crystallite size of the lithiophilic material may be 2 nm to 11 nm.

In one embodiment, a thickness of the coating layer may be 10 nm to 300 nm.

In one embodiment, a difference (dₘₐₓ−dₘᵢₙ) between a maximum value (dₘₐₓ) of a thickness of the coating layer and a minimum value (dₘᵢₙ) of a thickness of the coating layer may be 5 nm or less.

In one embodiment, the amount of the coating layer may be 10 weight percent (wt %) to 60 wt % based on the total weight of the anode active material.

In one embodiment, an all-solid-state battery may be provided. The battery may include an anode current collector and an anode active material layer including the anode active material described above and disposed on the anode current collector. The battery may also have a solid electrolyte layer including a solid electrolyte and disposed on the anode active material layer. The battery may further have a cathode active material layer including a cathode active material and disposed on the solid electrolyte layer and may have a cathode current collector disposed on the cathode active material layer.

In one embodiment, when a formation process is performed on the all-solid-state battery and the result thereof is represented as a graph where, graphically, an x-axis is capacity (mAh/g) and a y-axis is voltage (V), no plateau may be observed in a range where the state of charge (SoC) of the all-solid-state battery is 24% to 44%.

Also, in the above mentioned graph, a slope may be 1.7 or less but greater than 0.8.

Another aspect of the present disclosure provides a method of manufacturing an anode active material. The method may include: preparing carbon-based particles, a precursor of a carbide, and a precursor of a lithiophilic material. The method may also include forming a buffer layer provided to cover at least a portion of a surface of a core including the carbon-based particles. The method may further include forming a coating layer provided to cover at least a portion of a surface of the buffer layer. The buffer layer may include the carbide derived from the precursor of the carbide and the coating layer may include the lithiophilic material derived from the precursor of the lithiophilic material.

In one embodiment, forming the buffer layer and forming the coating layer may be performed using chemical vapor deposition (CVD).

As such, the carbide may include SiCₓ (0<x≤1).

In one embodiment, the precursor of the carbide may include silane gas and hydrocarbon gas.

In one embodiment, the lithiophilic material may include amorphous silicon (Si).

Also, the precursor of the lithiophilic material may include at least one selected from the group consisting of SiH₄, Si₂H₆, Si₃H₈, SiCl₄, SiHCl₃, Si₂Cl₆, SiH₂Cl₂, SiH₃Cl, or any combination thereof, where H is hydrogen and Cl is chlorine.

Also, forming the coating layer using chemical vapor deposition may be performed at a temperature of 700° C. or less, or 475° C. or less.

### BRIEF DESCRIPTION OF THE DRAWINGS

The above and other features of the present disclosure are described in detail referring to certain embodiments thereof illustrated in the accompanying drawings, which are given hereinbelow by way of illustration only, and thus are not limitative of the present disclosure, and wherein:

FIG. 1 shows a general configuration of an all-solid-state battery;

FIG. 2 shows the structure of an anode active material according to the present disclosure;

FIG. 3 shows an enlarged view of the structure of a surface of the anode active material according to the present disclosure;

FIG. 4 shows results of X-ray diffraction (XRD) for Preparation Example 1;

FIG. 5 shows results of XRD for Comparative Preparation Example 1;

FIG. 6 shows results of X-ray photoelectron spectroscopy (XPS) for Preparation Example 1;

FIG. 7 shows results of XPS for Comparative Preparation Example 1;

FIG. 8A shows an energy dispersive X-ray spectroscopy (EDS) image of elemental carbon (C) in Preparation Example 1;

FIG. 8B shows an EDS image of elemental carbon (C) and elemental silicon (Si) in Preparation Example 1;

FIG. 9A shows an EDS image of elemental carbon (C) in Comparative Preparation Example 1;

FIG. 9B shows an EDS image of elemental carbon (C) and elemental silicon (Si) in Comparative Preparation Example 1;

FIG. 10A shows an EDS image of elemental carbon (C) in Comparative Preparation Example 2;

FIG. 10B shows an EDS image of elemental carbon (C) and elemental silicon (Si) in Comparative Preparation Example 2;

FIG. 11 shows a charge/discharge graph for Example 1 and Comparative Example 1;

FIG. 12 shows an enlarged view of part of the charge/discharge graph according to FIG. 11;

FIG. 13 shows a charge/discharge graph for various Examples; and

FIG. 14 shows a charge/discharge graph for various Comparative Examples.

### DETAILED DESCRIPTION

The above and other objects, features, and advantages of the present disclosure should be more clearly understood from the following embodiments taken in conjunction with the accompanying drawings. However, the present disclosure is not limited to the embodiments disclosed herein and may be modified into different forms. These embodiments are provided to thoroughly explain the disclosure and to sufficiently transfer the spirit of the present disclosure to those of ordinary skill in the art.

Throughout the drawings, the same reference numerals refer to the same or like elements. For the sake of clarity of the present disclosure, the dimensions of structures may be depicted as being larger than actual size. It should be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It should be further understood that the terms “comprise”, “include”, “have”, etc., when used in this specification, specify the presence of stated features, integers, steps, operations, elements, components, or combinations thereof. However, such terms do not preclude the presence or addition of one or more other features, integers, steps, operations, elements, components, or combinations thereof. Also, it should be understood that, when an element such as a layer, film, area, or sheet is referred to as being “on” another element, the element may be directly on the other element, or intervening elements may be present therebetween. Similarly, when an element such as a layer, film, area, or sheet is referred to as being “under” another element, the element may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, the variable is intended to include all values including the end points described within the stated range. For example, the range of “5 to 10” should be understood to include any subranges, such as 6 to 10, 7 to 10, 6 to 9, 7 to 9, and the like, as well as individual values of 5, 6, 7, 8, 9 and 10, and should also be understood to include any value between valid integers within the stated range, such as 5.5, 6.5, 7.5, 5.5 to 8.5, 6.5 to 9, and the like. Also, for example, the range of “10% to 30%” should be understood to include subranges, such as 10% to 15%, 12% to 18%, 20% to 30%, etc., as well as all integers including values of 10%, 11%, 12%, 13% and the like up to 30%, and should also be understood to include any value between valid integers within the stated range, such as 10.5%, 15.5%, 25.5%, and the like.

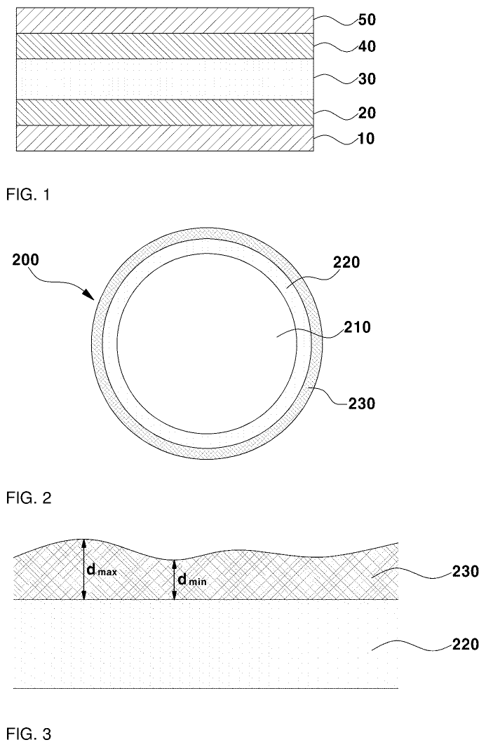

FIG. 1 shows an all-solid-state battery according to the present disclosure. Referring to FIG. 1, the all-solid-state battery may include: an anode current collector 10; an anode active material layer 20 including an anode active material according to the present disclosure and disposed on the anode current collector 10; a solid electrolyte layer 30 including a solid electrolyte and disposed on the anode active material layer 20; a cathode active material layer 40 including a cathode active material and disposed on the solid electrolyte layer 30; and a cathode current collector 50 disposed on the cathode active material layer 40.

The anode current collector 10 may be configured to transfer electrons to the anode active material or receive electrons from the anode active material during charging and discharging. The anode current collector 10 may be a plate-type substrate having electrical conductivity. Specifically, the anode current collector 10 may be in the form of a sheet, a thin film, or a foil.

The anode current collector 10 may include a material that does not react with lithium. Specifically, the anode current collector 10 may include at least one selected from the group comprising or consisting of nickel (Ni), copper (Cu), stainless steel, or any combination thereof.

The thickness of the anode current collector 10 is not particularly limited and may be, for example, 1 micrometer (μm) to 500 μm.

The solid electrolyte layer 30 may be disposed between the cathode active material layer 40 and the anode active material layer 20 and may include a solid electrolyte having lithium ion conductivity.

The solid electrolyte may include an oxide-based solid electrolyte, a sulfide-based solid electrolyte, or the like. Here, a sulfide-based solid electrolyte having high lithium ion conductivity may be used. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one selected from among Ge, Zn, and Ga), Li₂S—GeS₂, Li₂S—SiS₂—Li₃PO₄, Li₂S—SiS₂-LiₓMO_{y} (in which x and y are positive numbers, and M is any one selected from among P, Si, Ge, B, Al, Ga, and In), Li₁₀GeP₂S₁₂, and the like.

Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), and the like.

The cathode active material layer 40 may include a cathode active material, a solid electrolyte, a conductive material, and a binder. The cathode active material may be capable of storing and releasing lithium ions. Examples thereof may include a rock-salt-layer-type active material such as LiCoO₂, LiMnO₂, LiNiO₂, LiVO₂, Li₁₊ₓNi_{1/3}CO_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (in which M is at least one selected from among Al, Mg, Co, Fe, Ni, and Zn, 0<x+y<2), lithium titanate such as Li₄Ti₅O₁₂, and the like. Also, the cathode active material may be configured such that the surface thereof is coated with lithium metal oxide.

The conductive material may be configured to confer electrical conductivity to the cathode active material layer 40. Examples thereof may include carbon black, conductive graphite, ethylene black, carbon fiber, graphene, and the like.

The binder may be configured to physically bind each component included in the cathode active material layer 40. Examples thereof may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The solid electrolyte included in the cathode active material layer 40 may serve to increase lithium ion conductivity of the cathode active material layer 40 and is substantially the same as the solid electrolyte of the solid electrolyte layer 30. Thus, a detailed description thereof has been omitted. Here, “substantially the same” means that the type of solid electrolyte that may be used is the same and does not necessarily mean that the same solid electrolyte must be used.

The cathode current collector 50 may include a plate-type substrate having electrical conductivity. The cathode current collector 50 may include an aluminum foil. The thickness of the cathode current collector 50 is not particularly limited and may be, for example, 1 μm to 500 μm.

The anode active material layer 20 may include an anode active material and may further include a solid electrolyte, a binder, and a conductive material. Here, the solid electrolyte, the binder, and the conductive material included in the anode active material layer 20 are substantially the same as the solid electrolyte included in the solid electrolyte layer 30 and the binder and conductive material included in the cathode active material layer 40. Thus, a detailed description thereof has been omitted. Here, “substantially the same” means that the types of solid electrolyte, binder, and conductive material that may be used are the same and does not necessarily mean that the same solid electrolyte, binder, and conductive material must be used.

Below is a detailed description of the anode active material.

### Anode Active Material

FIG. 2 shows the anode active material 200 according to the present disclosure. Referring to FIG. 2, the anode active material 200 according to the present disclosure may include a core 210 including carbon-based particles, a buffer layer 220 covering at least a portion of the surface of the core 210 and including a carbide, and a coating layer 230 covering at least a portion of the surface of the buffer layer 220 and including a lithiophilic material. The anode active material 200 according to the present disclosure may have a core-shell structure with carbon-based particles as the core and the buffer layer 220 and the coating layer 230 as the shell, as shown in FIG. 2.

Here, the shape of the carbon-based particles is not particularly limited but, in one example, may be spherical.

In one embodiment, the carbon-based particles may be those capable of reversible intercalation and deintercalation of lithium and may include, for example, at least one selected from the group comprising or consisting of natural graphite, artificial graphite, or any combination thereof.

The buffer layer 220 may be interposed between the core 210 and the coating layer 230 to thus enhance adhesion between the core 210 and the coating layer 230. Specifically, the carbide and the lithiophilic material may be mixed at the interface between the buffer layer 220 and the coating layer 230. Here, carbon included in the carbide may serve to suppress the lithiophilic material from crystallizing and expanding in volume. Accordingly, it is possible to prevent detachment at the interface between the coating layer 230 and the buffer layer 220, which occurs due to repeated volume expansion and contraction of the coating layer 230 during charging and discharging of the all-solid-state battery.

Also, the buffer layer 220 may be uniformly formed on the surface of the core 210. As the buffer layer 220 is uniformly formed on the surface of the core 210, it may serve as a buffer for uniformly forming the coating layer 230.

When the buffer layer 220 and the coating layer 230 are uniformly formed on the core 210, even if volume expansion occurs due to charging, the coating layer 230 expands locally. This alleviates a phenomenon of stress being intensively applied to a specific portion, ultimately improving charge/discharge efficiency of the all-solid-state battery and increasing lifespan thereof.

The carbide included in the buffer layer 220 may be a compound of carbon (C) with one or more positive elements, particularly silicon carbide represented by SiCₓ (0<x≤1).

In one embodiment, the thickness of the buffer layer 220 may be 1 nm to 20 nm. If the thickness of the buffer layer 220 is less than 1 nm, buffer function of the buffer layer 220 may decrease. On the other hand, if the thickness of the buffer layer 220 exceeds 20 nm, energy density of the all-solid-state battery may decrease.

In one embodiment, the coating layer 230 covering at least a portion of the surface of the buffer layer 220 may include a material with high theoretical capacity. Particularly, a lithiophilic material that is a metal or metalloid capable of forming an alloy with lithium may be included.

In the detailed description, the lithiophilic material may refer to a material that forms and induces a lithium metal in a uniform form by minimizing nuclear formation resistance in a process in which lithium ions are reduced to lithium metal.

In one embodiment, the metal or metalloid capable of forming an alloy with lithium may include at least one selected from the group comprising or consisting of silicon (Si), gold (Au), platinum (Pt), palladium (Pd), silver (Ag), aluminum (AI), magnesium (Mg), bismuth (Bi), tin (Sn), zinc (Zn), or any combination thereof. Particularly, the lithiophilic material may include amorphous silicon (Si).

Charging of the all-solid-state battery is typically as follows. When voltage is applied to the all-solid-state battery, lithium ions are released from the cathode active material. The lithium ions may move to the anode active material layer 20 through the solid electrolyte layer 30 having lithium ion conductivity. The lithium ions are stored by intercalation into the anode active material (e.g., graphite) of the anode active material layer 20.

As such, when a lithiophilic material that is a metal or metalloid capable of forming an alloy with lithium is included as in the present disclosure, lithium ions are stored in the form of a lithium alloy with high energy density, thereby increasing the capacity of the all-solid-state battery.

In one embodiment, the crystallite size of the lithiophilic material may be 2 nm to 11 nm, and in one example may be 2 nm to 3 nm. Here, the crystallite size may be measured through X-ray diffraction (XRD) of the anode active material 200 including the coating layer 230.

Also, the crystallite size may be calculated using the following equation.

$$D = 0.9 \cdot λ / β \cdot cos θ \qquad [ Crystallite size equation ]$$

(in which D is the crystallite size (nm), λ is the X-ray wavelength (nm), β is the half width (rad) of the XRD graph peak, and θ is the half value of the XRD graph peak 2θ)

When the crystallite size of the lithiophilic material is 2 nm to 11 nm, a crystallization phenomenon in which the amorphous lithiophilic material changes to crystalline during charging may be suppressed. In particular, when the crystallite size of the lithiophilic material is 2 nm to 3 nm, the effect of suppressing crystallization may be highly exhibited.

In one embodiment, the thickness of the coating layer 230 may be 10 nm to 300 nm. Particularly, the thickness of the coating layer 230 may be 20 nm to 300 nm. If the thickness of the coating layer 230 is less than 10 nm, the capacity of the all-solid-state battery may decrease. On the other hand, if the thickness of the coating layer 230 exceeds 300 nm, the extent of volume expansion of the coating layer 230 may increase during charging, which may accelerate deterioration of the anode active material 200.

FIG. 3 shows the surface of the anode active material 200 according to the present disclosure. Here, the coating layer 230 is shown in a somewhat exaggerated manner to explain a difference between maximum and minimum values of the thickness, which will be described later.

In one embodiment, the difference (dₘₐₓ−dₘᵢₙ) between the maximum value (dₘₐₓ) of the thickness of the coating layer 230 and the minimum value (dₘᵢₙ) of the thickness of the coating layer 230 may be 10 nm or less. In one example, the difference (dₘₐₓ−dₘᵢₙ) between the maximum value (dₘₐₓ) of the thickness of the coating layer 230 and the minimum value (dₘᵢₙ) of the thickness of the coating layer 230 may be 5 nm or less. In another example, the difference (dₘₐₓ−dₘᵢₙ) between the maximum value (dₘₐₓ) of the thickness of the coating layer 230 and the minimum value (dₘᵢₙ) of the thickness of the coating layer 230 may be 1.5 nm or less.

In the anode active material 200 according to the present disclosure, the coating layer 230 may be more uniformly applied by forming a buffer layer 220 between the core 210 and the coating layer 230. The difference (dₘₐₓ−dₘᵢₙ) between the maximum value (dₘₐₓ) and the minimum value (dₘᵢₙ) of the thickness of the coating layer 230 indicates the uniformity of the coating layer 230.

Here, the difference (dₘₐₓ−dₘᵢₙ) between the maximum value (dₘₐₓ) of the thickness of the coating layer 230 and the minimum value (dₘᵢₙ) of the thickness of the coating layer 230 may be measured and calculated by subjecting the surface of the anode active material 200 to energy-dispersive X-ray spectroscopy (EDS).

Furthermore, when magnification is increased to the extreme during EDS imaging and the imaging range is limited to an extremely narrow range, the difference (dₘₐₓ−dₘᵢₙ) between the maximum value (dₘₐₓ) of the thickness of the coating layer 230 and the minimum value (dₘᵢₙ) of the thickness of the coating layer 230 will converge to 0 nm regardless of the actual coating uniformity of the coating layer. In one example, the magnification may be set to 20,000× to 100,000×.

If the difference (dₘₐₓ−dₘᵢₙ) between the maximum value (dₘₐₓ) of the thickness of the coating layer 230 and the minimum value (dₘᵢₙ) of the thickness of the coating layer 230 exceeds 10 nm, the coating layer 230 may be determined to be unevenly applied. In this case, when the all-solid-state battery including the anode active material 200 is charged, local volume expansion occurs, accelerating interfacial detachment between the core 210 and the buffer layer 220 or between the buffer layer 220 and the coating layer 230.

On the other hand, when the difference (dₘₐₓ−dₘᵢₙ) between the maximum value (dₘₐₓ) of the thickness of the coating layer 230 and the minimum value (dₘᵢₙ) of the thickness of the coating layer 230 is 5 nm or less, the coating layer 230 may be determined to be uniformly applied. In one example, when the difference (dₘₐₓ−dₘᵢₙ) between the maximum value (dₘₐₓ) of the thickness of the coating layer 230 and the minimum value (dₘᵢₙ) of the thickness of the coating layer 230 is 1.5 nm or less, the coating layer 230 may be determined to be very uniformly applied.

As such, uniform volume expansion occurs during charging of the all-solid-state battery including the anode active material 200. Thus, interfacial detachment between the core 210 and the buffer layer 220 or between the buffer layer 220 and the coating layer 230 may be prevented.

The amount of the coating layer 230 may be 10 weight percent (wt %) to 60 wt % based on the total weight of the anode active material 200. If the amount of the coating layer 230 is less than 10 wt % based on the total weight of the anode active material 200, the theoretical capacity of the anode active material 200 may decrease. On the other hand, if the amount of the coating layer 230 exceeds 60 wt %, volume expansion of the coating layer 230 may intensify, which may increase interfacial detachment.

A state of charge of the battery refers to how much energy is currently remaining. The percentage of storage (remaining) capacity available in the currently charged state relative to the maximum capacity that may be stored by fully charging the battery (battery storage capacity maximum) may be defined as “SoC (%)”. In this specification, SoC is referred to as “state of charge”

In this regard, when a formation process is performed on the all-solid-state battery including the anode active material 200 according to the present disclosure and the result thereof is graphed with the x-axis being capacity expressed as milliampere-hours per gram mass (mAh/g) and the y-axis being voltage (V), no plateau may be observed in the range where the state of charge (SoC) of the all-solid-state battery is 24% to 44%.

Here, plateau refers to a flat voltage on the graph, and may be due to crystallization of a lithiophilic material. For example, when amorphous silicon (Si) is used as the lithiophilic material and the structure of amorphous silicon changes to crystalline in the formation process of an all-solid-state battery including the same, the plateau may be observed. Conversely, if the plateau is not observed, it is understood that such crystallization has not occurred.

The all-solid-state battery including the anode active material 200 according to the present disclosure does not show plateau in the range where the state of charge (SoC) of the all-solid-state battery is 24% to 44%, which means that crystallization of the lithiophilic material does not occur. Accordingly, an irreversible decrease in capacity may be suppressed during initial charging and discharging. Furthermore, volume expansion of the layer 20 of the anode active material 200 may be suppressed.

Also, in the above mentioned graph, the slope may be 1.7 or less but greater than 0.8, and in one example may be 1.3 to 1.5. If the slope of the graph is 0.8 or less, crystallization of the lithiophilic material may occur to a certain extent. On the other hand, if the slope of the graph exceeds 1.7, the lithiophilic material may not fully function as an anode active material due to increased resistance of the material.

Below is a description of a method of manufacturing the anode active material 200.

### Method of Manufacturing Anode Active Material

A method of manufacturing the anode active material 200 according to the present disclosure includes: preparing carbon-based particles, a precursor of a carbide, and a precursor of a lithiophilic material; forming a buffer layer 220 provided to cover at least a portion of the surface of the core 210 including the carbon-based particles; and forming a coating layer 230 provided to cover at least a portion of the surface of the buffer layer 220.

Here, the carbon-based particles are capable of reversible intercalation and deintercalation of lithium and are substantially the same as those described for the anode active material 200. Thus, a detailed description thereof has been omitted.

The buffer layer 220 may include the carbide derived from the precursor of the carbide. The precursor of the carbide may be a material that is converted into the carbide through a predetermined deposition process. Specifically, the precursor of the carbide may include a precursor including carbon (C) and a precursor including a positive element that binds to carbon (C) to form the carbide. Also, a precursor including both carbon (C) and positive element may be used. Here, the precursor of the carbide may be provided in the form of a gas.

Also, the coating layer 230 may include a lithiophilic material derived from the precursor of the lithiophilic material. The precursor of the lithiophilic material may be a material that is converted into a lithiophilic material through a predetermined deposition process. Here, the precursor of the lithiophilic material may be provided in the form of a gas.

After preparing the carbon-based particles, the precursor of the carbide, and the precursor of the lithiophilic material in this way, the buffer layer 220 may be formed by coating the surface of the carbon-based particles with the carbide. Forming the buffer layer 220 may be performed using chemical vapor deposition (CVD). Through chemical vapor deposition, the precursor of the carbide may be converted into the carbide and the precursor of the lithiophilic material may be converted into the lithiophilic material.

Chemical vapor deposition is a process of forming a coating layer 230 on a material to be coated using chemical reaction of solid-gas or liquid-gas with different properties. CVD may be distinguished from chemical vapor reaction (CVR).

Forming the buffer layer 220 using chemical vapor deposition may be carried out under more mild conditions than those generally used in the relevant technical field in order to coat the surface of the carbon-based particles with the carbide. It is known that the process of applying carbon (C) using chemical vapor deposition may be generally performed at a high temperature of 900° C. to 1300° C. The process of applying the buffer layer 220 according to the present disclosure may be performed at a temperature lower than the above temperature. For example, chemical vapor deposition may be performed at 400° C. to 500° C.

Also, the thickness of the buffer layer 220 formed using chemical vapor deposition may be 1 nm to 20 nm.

The carbide in the buffer layer 220 may include SiCₓ (0<x≤1). Accordingly, the precursor of the carbide for forming the carbide represented as SiCₓ (0<x≤1) using chemical vapor deposition may include silane gas and hydrocarbon gas.

The silane gas is presented as a precursor including the positive element and may include, for example, at least one selected from the group comprising or consisting of SiH₄, Si₂H₆, Si₃H₈, SiCl₄, SiHCl₃, Si₂Cl₆, SiH₂Cl₂, SiH₃Cl, or any combination thereof, where H is hydrogen and Cl is chlorine. In one example, SiH₄ may be used.

The hydrocarbon gas is presented as a precursor including carbon (C) and may include, for example, at least one selected from the group comprising or consisting of methane (CH₄), acetylene (C₂H₂), ethylene (C₂H₄), or any combination thereof.

Thereby, a buffer layer 220 in which the carbide is uniformly applied onto the surface of the core 210 may be obtained.

According to the present disclosure, after forming the buffer layer 220 on the core 210 using chemical vapor deposition, the coating layer 230 may be formed by coating with a lithiophilic material. Here, forming the coating layer 230 may be performed using chemical vapor deposition (CVD).

The coating layer 230 is not directly applied onto the surface of the core 210 but is formed after uniformly forming the buffer layer 220 on the core 210, so the coating layer 230 may also be uniformly formed on the buffer layer 220.

Moreover, when the coating layer 230 is formed on the buffer layer 220, the carbide and lithiophilic material may be mixed at the interface between the buffer layer 220 and the coating layer 230. The carbon in the carbide may inhibit growth of the lithiophilic material at the interface and enable a smaller crystallite size.

In one embodiment, the lithiophilic material is a material with high theoretical capacity and may include a lithiophilic material that is a metal or metalloid capable of forming an alloy with lithium. The metal or metalloid capable of forming an alloy with lithium may include at least one selected from the group comprising or consisting of silicon (Si), gold (Au), platinum (Pt), magnesium (Mg), palladium (Pd), silver (Ag), aluminum (Al), bismuth (Bi), tin (Sn), zinc (Zn), or any combination thereof. In one example, the lithiophilic material may include amorphous silicon (Si).

Also, when amorphous silicon (Si) is used as the lithiophilic material, the precursor of the lithiophilic material may be silane gas. For example, the silane gas may include at least one selected from the group comprising or consisting of SiH₄, Si₂H₆, Si₃H₈, SiCl₄, SiHCl₃, Si₂Cl₆, SiH₂Cl₂, SiH₃Cl, or any combination thereof.

In addition, an anode active material 200 manufactured by the method of manufacturing the anode active material 200 is substantially the same as the anode active material 200 described above. Thus, a redundant description thereof has been omitted.

A better understanding of the present disclosure may be obtained through the following examples and comparative examples. However, these examples are not construed as limiting the technical spirit of the present disclosure.

### Preparation Example 1

In step (a), spherical natural graphite was prepared as carbon-based particles, and silane gas and ethylene (C₂H₄) were prepared as precursors of carbide. Also, the silane gas was used as a precursor of a lithiophilic material.

In step (b), the reactor of a device used for chemical vapor deposition was heated to about 475° C. under an argon (Ar) atmosphere. Thereafter, 50 grams (g) of the prepared spherical natural graphite was placed in the reactor and the prepared silane (SiH₄) gas and ethylene (C₂H₄) were injected at respective flow rates of 100 standard cubic centimeters per minute (sccm) and 32 sccm to coat the surface of the natural graphite with silicon carbide, thus forming a buffer layer. Forming the buffer layer was performed for about 70 minutes.

In step (c), after the temperature of the reactor was set to about 475° C., the silane gas was injected at a flow rate of 100 sccm for about 10 minutes to coat the surface of the buffer layer with silicon (Si), thus forming a coating layer.

Thereby, an anode active material in which the buffer layer including silicon carbide and the coating layer including silicon (Si) were formed on the core including carbon-based particles was obtained.

### Comparative Preparation Example 1

In step (a), spherical natural graphite was prepared as carbon-based particles, and silane gas and ethylene (C₂H₄) were prepared as precursors of carbide. Also, the silane gas was used as a precursor of a lithiophilic material.

In step (b), the reactor of a device used for chemical vapor deposition was heated to about 475° C. under an argon (Ar) atmosphere. Thereafter, 50 g of the prepared spherical natural graphite was placed in the reactor, and the prepared silane (SiH₄) gas was injected at a flow rate of 100 sccm to directly coat the surface of the spherical natural graphite with silicon (Si), thus forming a coating layer. Here, chemical vapor deposition was performed for about 73 minutes.

Thereby, an anode active material in which the coating layer including silicon (Si) was formed on the core including carbon-based particles was obtained.

### Comparative Preparation Example 2

An anode active material was manufactured in the same manner as in Example 1, with the exception that step (c) was not performed. Thereby, an anode active material in which a buffer layer including silicon carbide was formed on a core including carbon-based particles was obtained.

### Test Example 1—Analysis of Crystallite Size

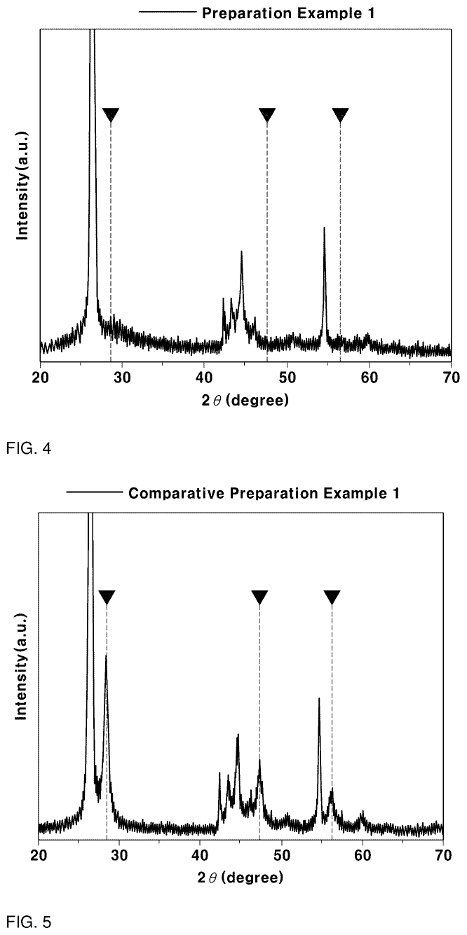

In order to determine the crystallite size of the anode active material manufactured according to the present disclosure, the anode active materials according to Preparation Example 1 and Comparative Preparation Example 1 were analyzed by XRD. The measurement range was θ=20° to 70°, and the results thereof are shown in FIGS. 4 and 5.

Referring to FIG. 4, no clear peaks were observed at 2θ=28°, 47°, and 56° representing the crystallinity of silicon. In addition, the crystallite size of silicon included in the coating layer was calculated to be 2.34 nm using the crystallite size equation, Equation 1 from above.

Referring to FIG. 5, distinct peaks were observed at 2θ=28°, 47°, and 56° representing the crystallinity of silicon, compared to FIG. 4. In addition, the crystallite size of silicon included in the coating layer was calculated to be 11.89 nm using the crystallite size equation, Equation 1 from above.

Based on the above results, it was confirmed that the effect of suppressing crystallization of silicon was evident in the anode active material including the core, the buffer layer, and the coating layer manufactured according to the present disclosure.

### Test Example 2—Analysis of Chemical Bond Form

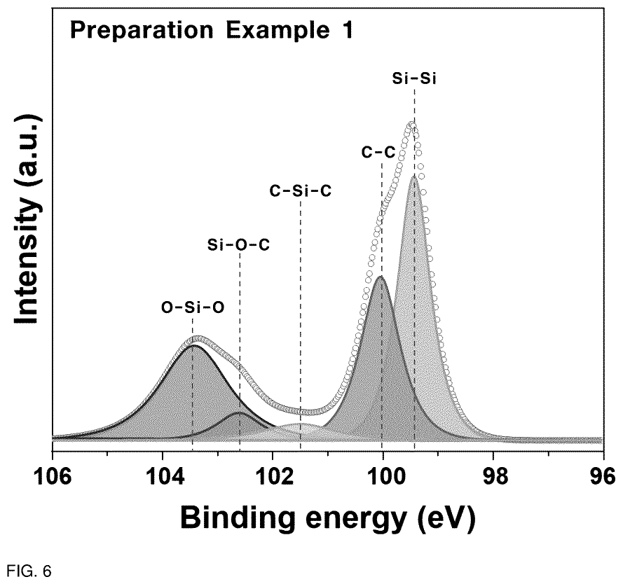

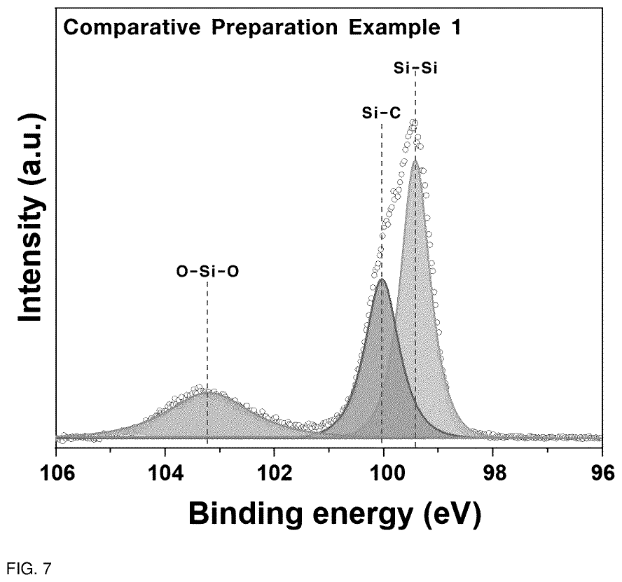

In order to analyze the components of the anode active material manufactured according to the present disclosure, the anode active materials according to Preparation Example 1 and Comparative Preparation Example 1 were analyzed by XPS. The results thereof are shown in FIGS. 6 and 7.

Comparing FIGS. 6 and 7, Si—Si, Si—C, and O—Si—O bonds were formed. However, in the anode active material according to Preparation Example 1 in which the coating layer was formed on the buffer layer, Si—O—C and C—Si—C bonds were formed.

Such bonds are estimated to be due to formation of the buffer layer including silicon carbide between the carbon-based particles and the coating layer.

### Test Example 3—Analysis of Coating Uniformity

In order to determine the coating uniformity of the anode active material manufactured according to the present disclosure, the surface of the anode active materials according to Preparation Example 1, Comparative Preparation Example 1, and Comparative Preparation Example 2 was analyzed by EDS.

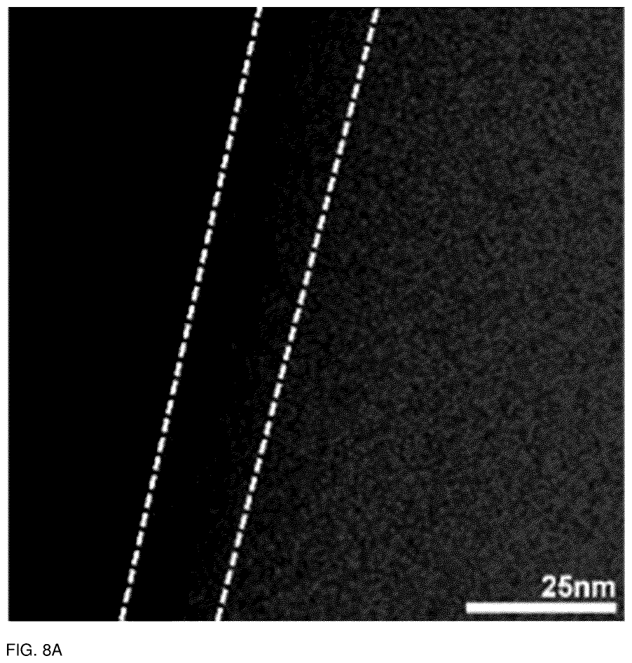

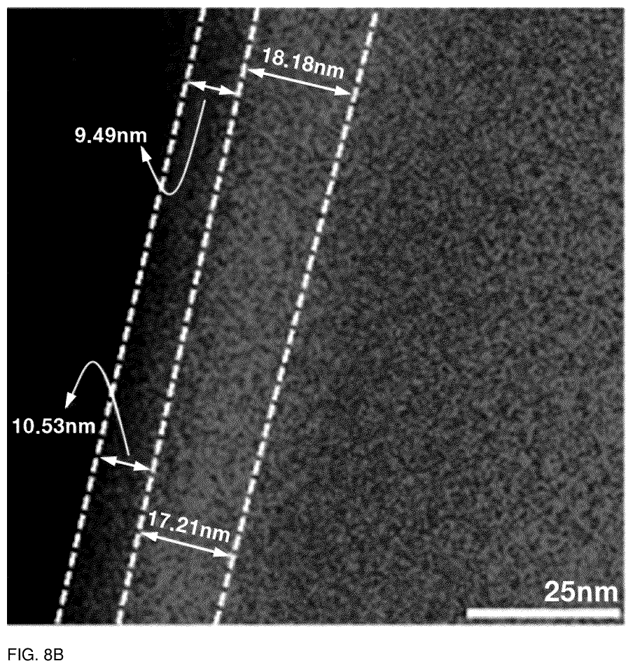

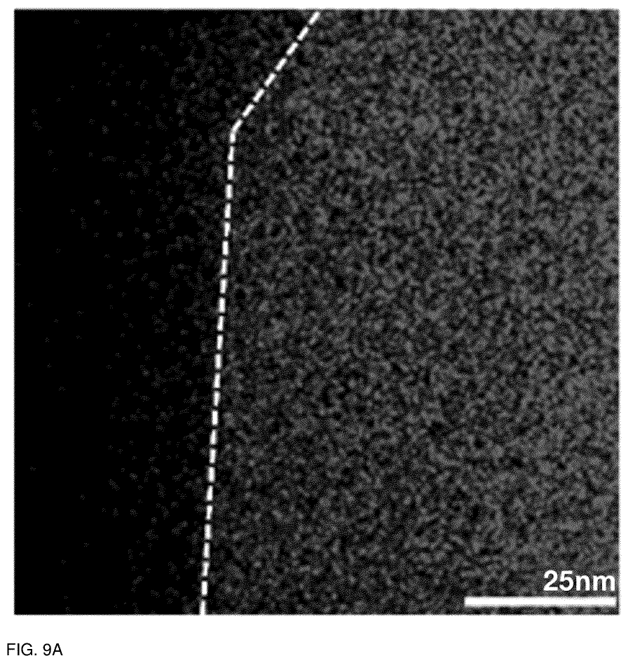

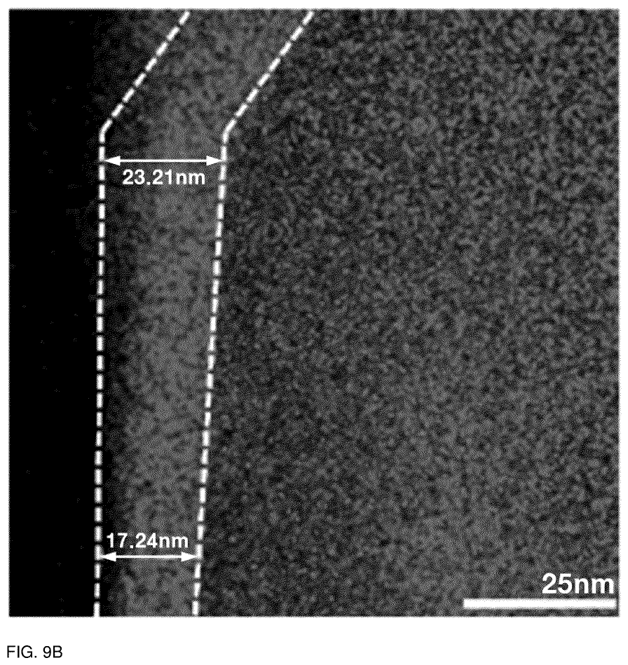

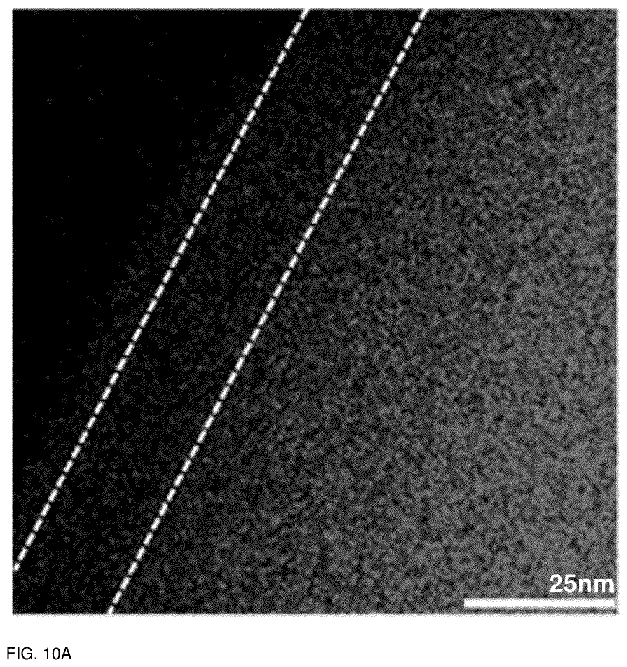

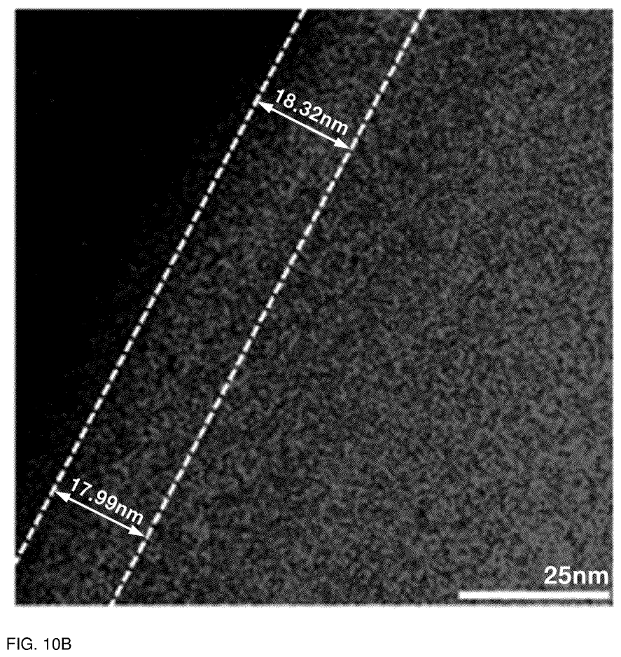

FIG. 8A shows the detection of elemental carbon (C) in Preparation Example 1, and FIG. 8B shows the detection of elemental carbon (C) and elemental silicon (Si). FIG. 9A shows the detection of elemental carbon (C) in Comparative Preparation Example 1, and FIG. 9B shows the detection of elemental carbon (C) and elemental silicon (Si). FIG. 10A shows the detection of elemental carbon (C) in Comparative Preparation Example 2, and FIG. 10B shows the detection of elemental carbon (C) and elemental silicon (Si).

The maximum thickness of the buffer layer, the minimum thickness of the buffer layer, the difference therebetween, the maximum thickness of the coating layer, the minimum thickness of the coating layer, and the difference therebetween in the anode active materials as shown in FIGS. 8B, 9B, and 10B are given in Table 1 below.

TABLE 1

| | | | | Comparative | | | Comparative | | |
|---|---|---|---|---|---|---|---|---|---|
| | Preparation Example 1 | | | Preparation Example 1 | | | Preparation Example 2 | | |
| | Max. | Min. | Difference | Max. | Min. | Difference | Max. | Min. | Difference |
| Category | (nm) | (nm) | (nm) | (nm) | (nm) | (nm) | (nm) | (nm) | (nm) |
| Buffer | 18.18 | 17.21 | 0.97 | — | — | — | 18.32 | 17.35 | 0.97 |
| layer | | | | | | | | | |
| Coating | 10.53 | 9.49 | 1.04 | 23.21 | 17.24 | 5.97 | — | — | — |
| layer | | | | | | | | | |

Referring to Table 1, the difference in thickness of the buffer layer in Preparation Example 1 was determined to be 0.97 nm, confirming that the buffer layer was uniformly formed on the carbon-based particles. In addition, the difference in thickness of the coating layer of Preparation Example 1 was determined to be 1.04 nm, confirming that the coating layer was uniformly formed on the buffer layer.

In contrast, in Comparative Preparation Example 1, in which silicon (Si) was directly applied onto the surface of the carbon-based particles, the difference in thickness of the coating layer was determined to be 5.97 nm, confirming that the coating layer was unevenly applied onto the carbon-based particles.

Also, in Comparative Preparation Example 2, the buffer layer including silicon carbide was uniformly applied, but the coating layer including silicon was not formed.

Manufacture of all-Solid-State Battery

In order to evaluate the electrochemical properties of an all-solid-state battery using the anode active material according to the present disclosure, an all-solid-state battery was manufactured by the following method.

### Example 1

An anode slurry was prepared by mixing the anode active material according to Preparation Example 1, a solid electrolyte, a binder, and a conductive material at a weight ratio of 58:39:2:1. Here, the solid electrolyte was an argyrodite sulfide-based electrolyte with a particle size of 500 nm to 1 μm, the conductive material was vapor grown carbon fiber (VGCF), and the binder was a solution obtained by dissolving butadiene rubber (BR) in hexyl butyrate as a solvent at a weight ratio of 6.3:93.7.

The anode slurry was applied onto nickel foil (Ni foil), which is an anode current collector, and then dried in an oven under an argon atmosphere at 80° C. for 10 minutes and in a vacuum at 100° C. for 2 hours or more to afford an anode plate.

An argyrodite sulfide-based solid electrolyte with a particle size of 3-5 μm and lithium metal with a thickness of 1T (1 mm) were stacked on the anode plate, after which a pressure of 58,000 N was applied thereto, thereby manufacturing an all-solid-state battery compression cell. As such, the all-solid-state battery compression cell was designed to have capacity of about 700 mAh/g.

### Comparative Example 1

An all-solid-state battery compression cell was manufactured in the same manner as in Example 1, with the exception that the anode active material according to Comparative Preparation Example 1 was used.

### Test Example 4—Formation Process

The compression cells according to Example 1 and Comparative Example 1 were subjected to a formation process under the following conditions. Here, the formation process is a process that activates the compression cell to be imparted with electrical characteristics and may be understood as the first charging and discharging of the all-solid-state battery. The conditions were:
Cut off voltage (V): 0.005-1.5 V (formation), 0.005-1.0 V (cycle)
Formation C-rate (C): 0.1C lithiation, 0.1C delithiation
Cycle C-rate (C): 0.3C lithiation, 0.3C delithiation

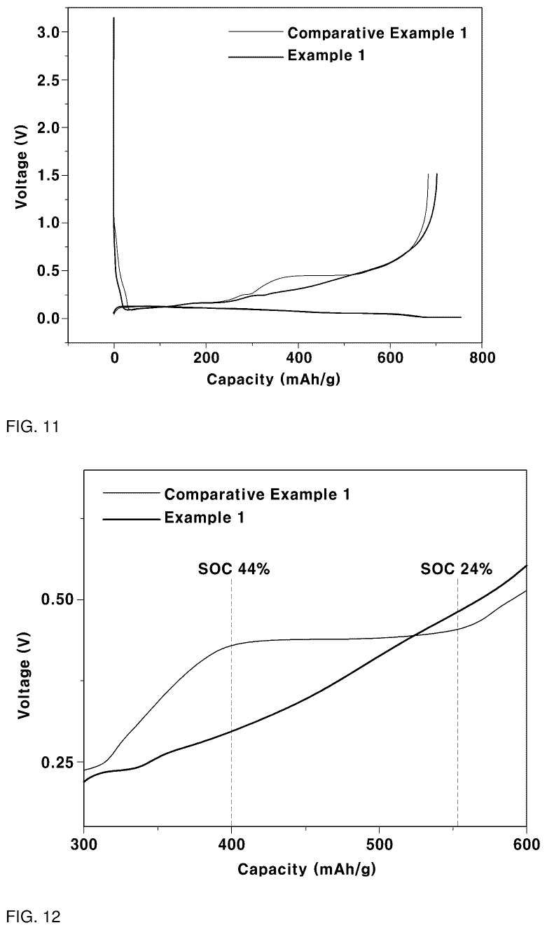

The results of the formation process for Example 1 and Comparative Example 1 are shown in FIG. 11, and the range including the state of charge (SoC) of 24% to 44% in FIG. 11 is enlarged and shown in FIG. 12. In addition, the related specific numerical values are listed in Tables 2 and 3 below.

TABLE 2

| | Discharge | Charge | Initial |
|---|---|---|---|
| | capacity | capacity | charge/discharge |
| Category | (mAh/g) | (mAh/g) | efficiency (%) |
| Comparative | 685 | 744 | 92.1 |
| Example 1 | | | |
| Example 1 | 704 | 755 | 93.2 |

TABLE 3

| | Category | | | | |
|---|---|---|---|---|---|
| | SoC (44%) | | SoC (24%) | | |
| | Capacity | Voltage | Capacity | Voltage | |
| Classification | (Ah/g) | (V) | (Ah/g) | (V) | Slope |
| Comparative | 0.402 | 0.42917 | 0.546 | 0.44966 | 0.143 |
| Example 1 | | | | | |
| Example 1 | 0.430 | 0.3252 | 0.614 | 0.58191 | 1.393 |

Referring to FIGS. 11 and 12, no plateau was observed in the compression cell according to Example 1. In contrast, plateau was observed in the compression cell according to Comparative Example 1.

These results show that, in Comparative Example 1, crystalline silicon grew around the state of charge (SoC) of 44% (about 0.43V) and crystallization progressed. However, in Example 1, it is understood that no plateau was observed due to inhibition of growth of crystalline silicon. Thereby, it was confirmed that crystallization was suppressed when forming the coating layer on the buffer layer.

### Test Example 5—Formation Process for Various Examples and Comparative Examples

In order to increase the reliability of Test Example 4, four all-solid-state battery compression cells were manufactured in the same manner as in Example 1. These were named Si/SiC/G-700(1); Si/SiC/G-700(2); Si/SiC/G-700(3); and Si/SiC/G-700(4). In addition, three all-solid-state battery compression cells were manufactured in the same manner as in Comparative Example 1. These were named Si/G-700(1); Si/G-700(2); and Si/G-700(3).

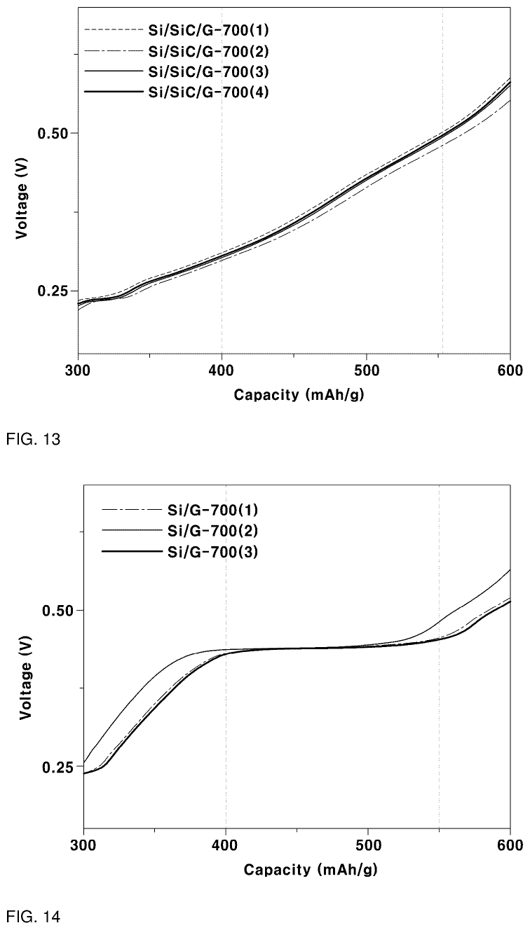

After formation process of a total of seven all-solid-state battery compression cells, the results thereof are shown in FIGS. 13 and 14. Also, the related specific numerical values are listed in Table 4 below. The specific test conditions are the same as Test Example 4.

TABLE 4

| | Category | | | | | |
|---|---|---|---|---|---|---|
| | SoC (44%) | | SoC (24%) | | | |
| Classi- | Capacity | Voltage | Capacity | Voltage | | |
| fication | (Ah/g) | (V) | (Ah/g) | (V) | Slope | |
| Si/SiC/G- | 0.422 | 0.33086 | 0.603 | 0.59537 | 1.461 | 1.393 ≤ |
| 700(1) | | | | | | x ≤ |
| Si/SiC/G- | 0.430 | 0.3252 | 0.614 | 0.58191 | 1.393 | 1.467 |
| 700(2) | | | | | | |
| Si/SiC/G- | 0.423 | 0.32367 | 0.604 | 0.58497 | 1.442 | |
| 700(3) | | | | | | |
| Si/SiC/G- | 0.424 | 0.32704 | 0.606 | 0.59353 | 1.467 | |
| 700(4) | | | | | | |
| Si/G-700(1) | 0.399 | 0.42841 | 0.570 | 0.47672 | 0.282 | 0.267 ≤ |
| Si/G-700(2) | 0.384 | 0.43208 | 0.548 | 0.47596 | 0.267 | x ≤ |
| Si/G-700(3) | 0.402 | 0.42917 | 0.574 | 0.4758 | 0.271 | 0.282 |

Referring to FIG. 13, no plateau was observed in any of the four all-solid-state battery compression cells manufactured in the same manner as in Example 1. Also, referring to FIG. 14, plateaus were observed in all three all-solid-state battery compression cells manufactured in the same manner as in Comparative Example 1.

Moreover, the four all-solid-state battery compression cells manufactured in the same manner as in Example 1 as shown in Table 3 had slopes of 1.393 to 1.467. Also, the three all-solid-state battery compression cells manufactured in the same manner as in Comparative Example 1 had slopes of 0.267 to 0.282.

According to the present disclosure, adhesion between a core and a coating layer can be enhanced by sequentially coating the core including carbon-based particles with a buffer layer including carbide and a coating layer including a lithiophilic material.

In addition, a uniform coating layer can be obtained by applying the lithiophilic material onto the buffer layer rather than directly coating the carbon-based particles with the lithiophilic material.

In addition, by growing the coating layer at a relatively low temperature of 700° C. or less, or 450 C or less, growth of crystalline silicon can be suppressed, and volume expansion of the anode active material layer can be reduced.

The effects of the present disclosure are not limited to the above-mentioned effects. It should be understood that the effects of the present disclosure include all effects that can be inferred from the description of the present disclosure.

As the embodiments of the present disclosure have been described above, those of ordinary skill in the art will appreciate that various modifications and alterations are possible through change, deletion or addition of components without departing from the scope and spirit of the disclosure as disclosed in the accompanying claims, which will also be said to be included within the scope of rights of the present disclosure.

What is claimed is:

1. An anode active material, comprising:
a core comprising carbon-based particles;
a buffer layer covering at least a portion of a surface of the core and comprising a carbide; and
a coating layer covering at least a portion of a surface of the buffer layer and comprising a lithiophilic material.

2. The anode active material of claim 1, wherein the carbon-based particles comprise at least one selected from the group consisting of natural graphite, artificial graphite, or any combination thereof.

3. The anode active material of claim 1, wherein the carbide comprises silicon (Si) and carbon (C) according to SiCₓ, where 0<x≤1.

4. The anode active material of claim 1, wherein a thickness of the buffer layer is 1 nanometer (nm) to 20 nm.

5. The anode active material of claim 1, wherein the lithiophilic material comprises a metal or metalloid capable of forming an alloy with lithium, and wherein the metal or metalloid capable of forming an alloy with lithium comprises at least one selected from the group consisting of silicon (Si), gold (Au), platinum (Pt), palladium (Pd), silver (Ag), aluminum (AI), bismuth (Bi), tin (Sn), zinc (Zn), or any combination thereof.

6. The anode active material of claim 1, wherein the lithiophilic material comprises amorphous silicon (Si).

7. The anode active material of claim 1, wherein a crystallite size of the lithiophilic material is 2 nm to 11 nm.

8. The anode active material of claim 1, wherein a thickness of the coating layer is 10 nm to 300 nm.

9. The anode active material of claim 1, wherein a difference (dₘₐₓ−dₘᵢₙ) between a maximum value (dₘₐₓ) of a thickness of the coating layer and a minimum value (dₘᵢₙ) of a thickness of the coating layer is 5 nm or less.

10. The anode active material of claim 1, wherein an amount of the coating layer is 10 weight percent (wt %) to 60 wt % based on a total weight of the anode active material.

11. An all-solid-state battery, comprising:
an anode current collector;
an anode active material layer disposed on the anode current collector, wherein the anode active material comprises:
(i) a core comprising carbon-based particles,
(ii) a buffer layer covering at least a portion of a surface of the core and comprising a carbide, and
(iii) a coating layer covering at least a portion of a surface of the buffer layer and comprising a lithiophilic material;
a solid electrolyte layer comprising a solid electrolyte and disposed on the anode active material layer;
a cathode active material layer comprising a cathode active material and disposed on the solid electrolyte layer; and
a cathode current collector disposed on the cathode active material layer.

12. The all-solid-state battery of claim 11, wherein, when a formation process is performed on the all-solid-state battery and a result thereof is represented as a graph where an x-axis is capacity expressed as milliampere-hours per gram mass (mAh/g) and a y-axis is voltage (V), no plateau is observed in a range where a state of charge (SoC) of the all-solid-state battery is 24% to 44%.

13. The all-solid-state battery of claim 11, wherein, when a formation process is performed on the all-solid-state battery and a result thereof is represented as a graph where an x-axis is capacity (mAh/g) and a y-axis is voltage (V), a slope of the graph is 1.7 or less but greater than 0.8 in a range where a state of charge (SoC) of the all-solid-state battery is 24% to 44%.

14. A method of manufacturing an anode active material, the method comprising:
preparing carbon-based particles, a precursor of carbide, and a precursor of a lithiophilic material;
forming a buffer layer provided to cover at least a portion of a surface of a core that comprises the carbon-based particles; and
forming a coating layer provided to cover at least a portion of a surface of the buffer layer,
wherein the buffer layer comprises carbide derived from the precursor of the carbide, and
wherein the coating layer comprises the lithiophilic material derived from the precursor of the lithiophilic material.

15. The method of claim 14, wherein forming the buffer layer and forming the coating layer are performed using chemical vapor deposition (CVD).

16. The method of claim 14, wherein the carbide comprises silicon (Si) and carbon (C) according to SiCₓ, where 0<x≤1.

17. The method of claim 14, wherein the precursor of the carbide comprises silane gas and hydrocarbon gas.

18. The method of claim 15, wherein the lithiophilic material comprises amorphous silicon (Si).

19. The method of claim 14, wherein the precursor of the lithiophilic material comprises at least one selected from the group consisting of SiH₄, Si₂H₆, Si₃H₈, SiCl₄, SiHCl₃, Si₂Cl₆, SiH₂Cl₂, SiH₃Cl, or any combination thereof, where H is hydrogen and Cl is chlorine.

20. The method of claim 15, wherein forming the coating layer using chemical vapor deposition is performed at a temperature of 475° C. or less.
